(19) United States
(12) Patent Application Publication
(10) Pub. No.: US 2008/0268812 A1
(43) Pub. Date: Oct. 30, 2008

(54) Method and System For Prepaid Calls on Postpaid Bills

(75) Inventor: Wilhelm Werner Meincke, Ratingen (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: KONINKLIJKE KPN N.V., The Hague (NL)

(21) Appl. No.: 12/158,324

(22) PCT Filed: Dec. 12, 2006
(86) PCT No.: PCT/EP2006/011930

§ 371 Date: Jun. 20, 2008

Related U.S. Application Data
(60) Provisional application No. 60/754,023, filed on Dec. 23, 2005.

(51) Int. Cl. H04M 11/00; H04M 15/00

(52) U.S. Cl. 455/406; 379/114.2

(57) ABSTRACT

The application relates to the service “pre-paid calls on post-paid bill”. If, for example, there is no money left on a caller's pre-paid account when calling a specific number, the call is charged to the post-paid subscription of a subscriber who agreed to take over the costs for these specific calls. Or if a business buys pre-paid cards for his staff, calls of the employees on working days in the office hours are billed on the post-paid bills of the business rather than on the pre-paid cards.

### RELATED APPLICATIONS

This application claims the benefit of U.S. Provisional Application No. 60/754,023, filed Dec. 23, 2005.

### FIELD OF THE INVENTION

The invention relates to a method of providing to a subscriber a service on a telecommunications network that also supplies a pre-paid service.

### BACKGROUND ART

The term “pre-paid” as commonly used within the context of telecommunications refers to a service that is being provided by a telecommunications service provider and that has been paid for in advance by the user. Accordingly, the user has created a usage credit.

A typical example of a pre-paid service is the pre-paid telephone call. This service can be implemented in a variety of ways. One way is to provide pre-paid calling cards. When a user makes a call using this card, the value of the card decreases depending on the costs associated with this specific call. The costs may depend on the duration of the call, on whether it is a local or a long-distance call, etc. Another way of implementing a pre-paid telephone call service is to have the operator manage accounts held by customers who have paid money in advance. This service typically provides a toll-free number that the customer can dial in to, whereupon he/she identifies him/herself by means of typing in a predetermined identification number in order to proceed to making the intended call. Yet another way to implement a pre-paid telephone call service is to supply pre-paid mobile telephones. This kind of service is also referred to as “pay-as-you-go”. In a typical scenario involving a pre-paid mobile phone, the user has got an initial credit for a certain amount of money, and needs to purchase extra credit when required.

### SUMMARY OF THE INVENTION

Most of the network operators/service providers have introduced pre-paid subscriptions, often implemented as service logic at an Intelligent Network platform. The expression “Intelligent Network” commonly refers to a network architecture for both fixed and mobile telecommunication networks. This architecture enables the operators to add value-added services on top of the standard telecommunications services. These kinds of value-added services are very powerful but complex. The flexibility is low and the implementation and integration of a new feature into the Intelligent Network are expensive and time consuming.

The invention provides a method of providing a service on a telecommunications network that also provides pre-paid services. The service in the invention can readily be integrated to avoid any changes to the existing, complex pre-paid service packages. The service in the invention can be implemented as a separate, new and highly flexible cost-efficient software application on separate service platforms.

More specifically, the invention relates to a method of providing to a subscriber a first service on a telecommunication network. The method enables the subscriber to specify in advance that costs of a telecommunication session on the network be charged to an account of the subscriber under given conditions. The conditions include that the session be initiated in a second service on the network, the second service being a pre-paid service, and that the session have a characteristic pre-determined by the subscriber. The method further comprises determining if a specific session on the network is initiated from the pre-paid service and determining if the specific session has the pre-determined characteristic. If the specific session is initiated in the pre-paid service and if the specific session has the predetermined characteristic, then specific costs of the specific session are charged to the subscriber's account, else the specific costs are not charged to this account.

Preferably, the method comprises enabling the subscriber to modify the pre-determined characteristic. The method of the invention preferably enables the subscriber to specify or modify the characteristic by means of providing to the subscriber access to a web site for specifying the characteristic or for modifying the characteristic. Alternative means to enable the subscriber to specify or modify the characteristic comprises automatic email processing, or an automated procedure offering via the telephone options in a voice-recorded menu and enabling the user to select or numerically specify the options through the telephone's keypad, etc.

Preferably, the characteristic is representative of at least one of the following: an identity of an initiator of the specific session (e.g., the telephone number of the person placing the call if the session relates to a telephone call); an identity of another party involved in the specific session (e.g., the telephone number of the person to whom the call is being made); a temporal aspect of the specific session (e.g., the time of day, the day of the week, the season, the duration of the session, etc.); a geographic aspect of the specific session (e.g., whether the session relates to a local call or to a long-distance call, or whether the session uses certain area codes).

For completeness, reference is made to the concept of “collect calls”. In the USA and Canada, a collect call (or “calling collect”) is a telephone call wherein a person makes a call to another person at the called person's expense. Collect calls used to require assistance from a human operator. Nowadays, it is possible to make a collect call without intervention of the human operator because of computer-based telephone dialing equipment. In contrast, the invention lets a subscriber to the service specify in advance whether the costs of future pre-paid telecommunication sessions are to be charged to the subscriber's account and under what conditions.

### BRIEF DESCRIPTION OF THE DRAWING

The invention is explained in further detail, by way of example and with reference to the accompanying drawing, wherein:

FIG. 1 is a diagram illustrating a system in the invention; and

FIG. 2 is a diagram illustrating a process in the invention.

### DETAILED EMBODIMENTS

A subscriber with a post-paid subscription can take over the cost of calls of a pre-paid subscriber under certain conditions (e.g., for specific destination numbers, for a range of destination numbers, depending or time and/or date, etcetera.). These conditions are preferably predetermined and modifiable by the post-paid subscriber. The pre-paid subscriber can establish these calls even if the pre-paid subscriber has no account or no balance on the pre-paid account. In the following embodiments a service supporting these requirements, is called “pre-paid calls on post-paid bill”, or in short “PPC on PPB”.

As a first example of such a scenario, consider a father who has a post-paid subscription and buys for his son a pre-paid card from the same GSM network operator/service provider. The father wants to ensure that his son can reach the parents, the grandfather and the neighbors, even when there is no money left on the son's pre-paid account. To enable this, the father takes over the cost of these specific calls under the condition that his son's pre-paid account is empty. Alternatively, the father always pays for these specific calls.

As a second example, consider a business manager who buys pre-paid Cards for his staff to support a comfortable split in business and private calls. For example, the calls of the employees in the national networks on working days in the office hours are billed on the manager's post-paid bills independent of the status of the pre-paid account. All other calls are charged to the pre-paid account of the employees.

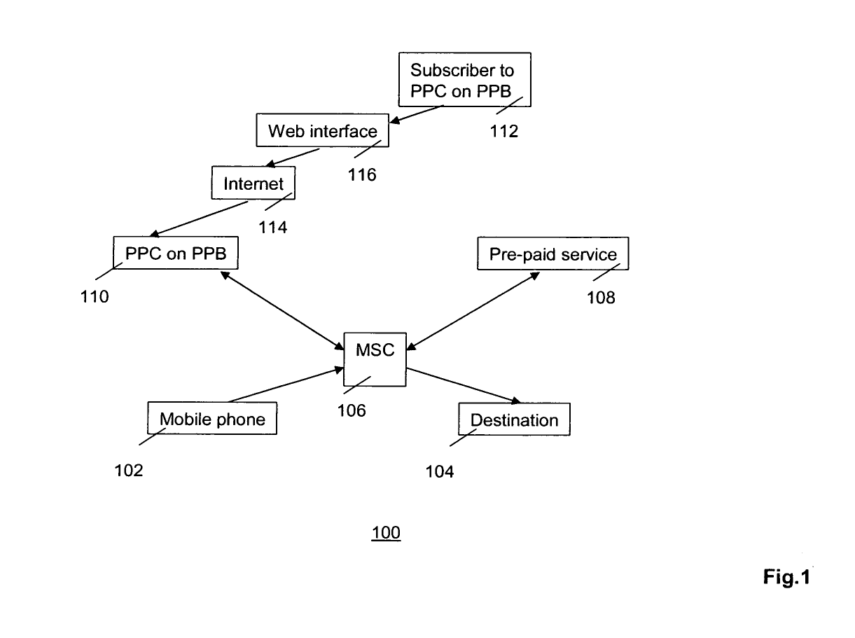

FIG. 1 is a block diagram of a system 100 implementing the method of the invention. System 100 comprises a mobile telephone 102 using a pre-paid service, a receiver at a destination 104, a mobile switching center (MSC) 106, service logic 108 for implementing the pre-paid service, and service logic 110 for implementing the “PPC on PPB” service. The expression “mobile switching center” and acronym MSC are commonly used to refer to a telephone exchange that provides circuit-switched calls, enables tracking of the geographic locations of the subscribers, and provides GSM services to mobile users within the geographical region covered.

With reference to FIG. 1, a scenario is now discussed wherein the “PPC on PPB” service is not being used. In this scenario, the user of mobile telephone 102 initiates a call to destination 104 by dialing the telephone number associated with destination 104. The user uses the pre-paid service. When this call is being initiated, MSC 106 invokes the pre-paid service at service logic 108, based on the identity of the user of mobile telephone 102 (e.g., via his/her PIN), or based on the identity of mobile phone 102 itself. The pre-paid service checks the account of the user of mobile telephone 102. If the balance of this account is adequate, service logic 108 instructs MSC 106 to route the call to destination 104. The costs of the call will be deducted from the user's account under control of service logic 108. If the balance is not adequate, service logic 108 instructs MSC 106 to block the call. With reference to FIG. 1, a further scenario is now discussed wherein the “PPC on PPB” service is being used. First, a subscriber 112 to the “PPC on PPB” service specifies that costs of a pre-paid telecommunication session in system 100 be charged to an account of the subscriber if the session has one or more characteristics pre-determined by subscriber 112. Then the network operator, who manages MSC 106, service logic 108 and service logic 110, sets the parameters associated with the pre-determined characteristics in the relevant components of system 100 that are needed to support the “PPC on PPB” service. Subscriber 112 can administer the characteristics or the parameters for handling the calls from mobile phone 102, e.g., via the Internet 114 through a web interface 116. The parameters are representative of the characteristics and define the rules that determine in advance which costs of what calls made from mobile 102 using the pre-paid service, are to be charged to the account of subscriber 112. Examples of the characteristic to be specified by subscriber 112 are one or more of the following: a single destination number or a list of multiple destination numbers; number ranges of destination numbers; area codes in the fixed network; working days (e.g., Monday to Friday); working times (e.g., 8 am to 17 pm on working days), duration of the call; local call or long-distance call; etc. Any single one of the example characteristics or any combination of example characteristics is feasible. In addition, subscriber 112 could also specify that the costs are to be apportioned between subscriber 112 and the user of mobile phone 102, thus allowing for yet another degree of control.

After the user of mobile 102 has dialed the number of destination 104, MSC 106 is triggered based on identity of mobile phone 102 and invokes the “PPC on PPB” service implemented by service logic 110. The “PPC on PPB” service checks the parameter of the call against the stored parameter in service 110.

If there is no match, service logic 110 instructs MSC 106 to continue with invoking of the pre-paid service implemented by service logic 108. The call will be then handled by the pre-paid service as a normal pre-paid call as described in the first scenario.

If there is a match, service logic 110 instructs MSC 106 to route the call directly to destination 104 without any invocation of the pre-paid service. Service logic then modifies the call detail record (CDR) at MSC 106 for this call, or generates an additional CDR for this call. The billing system (not shown) can use this record to write the cost of the call on the bill of subscriber 112.

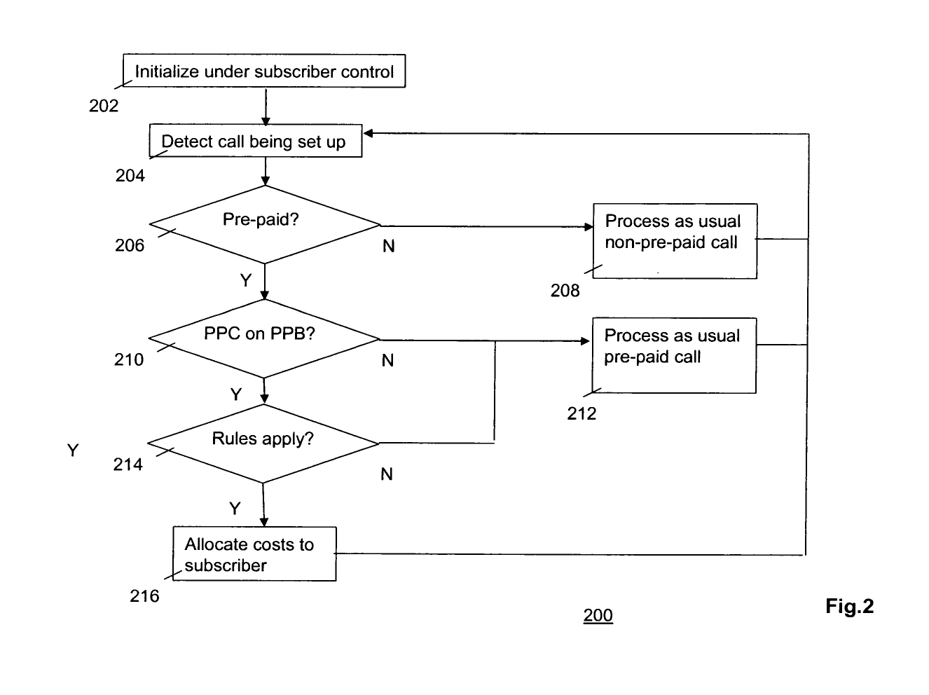

FIG. 2 is a process diagram illustrating a method 200 in the invention. In a step 202, the process of the invention is initialized by subscriber 112 by specifying the rules under which calls made from mobile phone 102 are to be charged, entirely or partly, to the account of subscriber 112 as discussed above. In a step 204, system 100 detects that a call is being set up. In a step 206, system 100 determines if the call should be processed as a call in a pre-paid service. If the call is not a pre-paid call, system 100 processes the call as a common non-pre-paid call in a step 208, whereupon the process returns to step 204 awaiting the next call on the network of system 100. If the call is identified as being made in a pre-paid service, it is determined in a step 210, if the call is eligible for invoking the “PPC on PPB” service. If it is determined that the call is not eligible, the call is being processed as a usual pre-paid call in a step 212. If it is determined that the call is eligible, it is determined in a step 214 if the rules apply as set up by subscriber 112 in initial step 202. If the rules do not apply, the call is being processed as a usual pre-paid call in step 212. If the rules do apply, the costs are allocated, in a step 216, partly or entirely to the account of subscriber 112 according to the rules as specified. The process then returns to step 204 for awaiting a next call.

The invention has been illustrated above with reference to the processing of a telecommunication session that includes a telephone call. The invention is similarly applicable to other telecommunication sessions that include, for example, pre-paid email services, or pre-paid SMS services, or pre-paid download services for downloading information content from web sites via the Internet. The telephone number of the session initiator is then to be replaced by the network address of the initiator.

1. A method of providing to a subscriber (112) a first service (110) on a telecommunication network (100), the method comprising:
enabling the subscriber to specify (202) in advance that costs of a telecommunication session on the network be charged to an account of the subscriber if the session is initiated in a second service (108) on the network, the second service being a pre-paid service, and if the session has a characteristic pre-determined by the subscriber;
determining (206) if a specific session on the network is initiated from the pre-paid service and, if so, determining (214) if the specific session has the pre-determined characteristic;
if the specific session is initiated in the pre-paid service and if the specific session has the predetermined characteristic, then charging (216) specific costs of the specific session to the account, and else not charging the specific costs to the account.

2. The method of claim 1, comprising enabling the subscriber to modify the characteristic.

3. The method of claim 1, wherein the enabling comprises the step of providing to the subscriber access to a web site for specifying the characteristic or for modifying the characteristic.

4. The method of claim 1, wherein the characteristic is representative of at least one of the following:
an identity of an initiator of the specific session;
an identity of another party involved in the specific session;
a temporal aspect of the specific session (time of day or duration);
a geographic aspect of the specific session.

5. The method of claim 1, wherein the characteristic relates to apportioning the costs between the subscriber and an initiator of the session.

6. The method of claim 1, wherein the specific session relates to making a telephone call.
